(19) United States
(12) Patent Application Publication
(10) Pub. No.: US 2022/0332889 A1
(43) Pub. Date: Oct. 20, 2022

(54) Polyamide Composition

(71) Applicant: BASF SE, Ludwigshafen am Rhein (DE)

(72) Inventors: Louise-Anne FILLOT, Beynost (FR); Thierry BADEL, Lyon (FR); Franco Enrico SPERONI, Ceriano Laghetto (IT)

(21) Appl. No.: 17/754,199

(22) PCT Filed: Sep. 25, 2020
(86) PCT No.: PCT/EP2020/076930

§ 371 Date: Mar. 25, 2022

(30) Foreign Application Priority Data
Sep. 30, 2019 (EP) 19306234.6

(51) Int. Cl. C08G 69/16; C08K 5/053; C08K 3/16

(52) U.S. Cl. CPC C08G 69/16; C08K 5/053; C08K 3/16

(57) ABSTRACT

Described herein is a polyamide composition [composition (C)] including: from 0 to 30% wt of at least one polyamide [polyamide (A)]; and from above 30 to 99.99% wt of at least one branched polyamide different from polyamide (A).

### TECHNICAL FIELD

The present invention relates to the field of polyamide compositions having improved ageing and cyclic stress resistance behaviour, such as fatigue, or resistance to pressure pulsations.

### BACKGROUND ART

Polyamides are synthetic polymers widely used for the manufacture of diverse shaped articles, including moulded and injected parts, which are often proposed for the high end electrical, electronic, and automotive industry.

In these fields of use, the moulded polyamide article during its normal useful lifetime is in contact with a heat source which frequently attains and/or which attains for a longer period temperatures largely exceeding 100° C. The heat source may be a heat producing device or a heated device or may be the surrounding environment wherein the moulded article is placed. Examples of heated devices or heat generating devices are engines, or elements thereof, and electrical and electronic devices such as circuit breakers, connectors, inverters, LEDs etc. For the automotive segment high-temperature-use application are regularly found in so-called under-the-hood or under-the-bonnet applications, herein referred to as high temperature automotive applications. Therefore, the invention in particular relates to polyamide suitable for the manufacture of moulded articles for use in the electro, electronic, and automotive industry.

Moulded articles for the electrical, electronic and automotive industry and moulding compositions based on polyamides generally have to comply with a complex property profile, including, for the compositions as moulded, good dimensional stability, high heat distortion temperature (HDT) and good mechanical properties, such as a high tensile strength, tensile modulus and fatigue. Polyamide materials generally tend to show a decrease in mechanical properties due to thermal degradation of the polymer. This effect is called heat ageing. This effect can occur to an undesirable extent. In particular with polyamides as the thermoplastic polymer, the deteriorating effect of exposure to high temperatures can be very dramatic.

In attempts to improve heat aging characteristics, it has been conventional practice to add heat stabilizers to polyamide compositions. The function of a heat stabilizer is to better retain the properties of the composition upon exposure of the moulded article to elevated temperature. When using a heat stabilizer, the useful lifetime of the moulded material can be extended significantly, depending on the type of material, use conditions and type and amount of heat stabilizer. Examples of heat stabilizers typically used in polyamides are organic stabilizers, like phenolic antioxidants and aromatic amines, and copper, either in the form of a copper salt in combination with potassium iodide or potassium bromide, or in the form of elementary copper, and metal powders, in particular iron powders.

Existing technologies, while leading to improvements of long-term heat aging resistance, are nevertheless insufficient for more demanding applications, involving exposure to higher temperatures; in many applications, retention of mechanical properties after long-term exposure to temperatures as high as 160° C., or even 180-200° C. and higher becomes a basic requisite. The number of specialty applications, requiring compositions with improved heat ageing properties is also increasing.

Within this scenario, U.S. Pat. No. 4,945,129 discloses a polyamide composition comprising (i) an amine-terminated polyamide, which is preferably of polycaprolactam-type, and which can comprise branching materials such as Jeffamine products (i.e. propylene oxide triamines), or tri- and tetra-functional ethylene amines; (ii) another additional polyamide and (iii) an olefin reactive copolymer. The composition can further comprise stabilizers and inhibitors of oxidative, thermal and UV light degradation, with combinations of Group I metal halides and cuprous halides being mentioned. Such compositions are shown as possessing improved impact strength, in particular at low temperature.

Further, WO 2013/004531 discloses a polyamide composition comprising:
a pre-polymer Y, obtained from polycondensation of polyfunctional monomer and mixture of AA/BB monomers and AB monomers, having a molecular weight of 600-3500 g/mol, said pre-polymer having preferably unbalanced end groups, and in particular an excess of amine end groups;
a first linear pre-polyamide X1 predominantly consisting of AA-BB repeating units; and
a second linear pre-polyamide X2 predominantly consisting of AB repeating units. The composition can further comprise usual additives, e.g. heat stabilizers and antioxidants. The above composition is mixed in the molten state to provide by reactive extrusion a high molecular weight branched polyamide, in which the difference between concentration of amine and carboxylic acid end groups (AEG-CEG) ranges generally of from 0 to 35 meq/kg (i.e. providing for a slight excess of amine end groups).

Similarly, WO 2013/004548 discloses a polyamide composition comprising:
a pre-polymer Y, obtained from polycondensation of polyfunctional monomer and mixture of AA/BB monomers, having a molecular weight of 600-3500 g/mol, said pre-polymer having preferably unbalanced end groups, and in particular an excess of amine end groups;
a linear pre-polyamide X consisting of AA-BB repeating units. The composition can further comprise usual additives, e.g. heat stabilizers and antioxidants. The above composition is mixed in the molten state to provide by reactive extrusion a high molecular weight branched polyamide, in which the difference between concentration of amine and carboxylic acid end groups (AEG-CEG) ranges generally of from 0 to 35 meq/kg (i.e. providing for a slight excess of amine end groups).

U.S. Pat. No. 9,856,375 discloses a polyamide composition [composition (C)] comprising:
from 20 to 95% wt of at least one polyamide [polyamide (A)];
from 1 to 30% wt of at least one branched polyamide different from polyamide (A), said branched polyamide comprising recurring units derived from polycondensation of a mixture [mixture (B)] comprising:
at least one polyamine monomer comprising at least three amine functional groups selected from the group consisting of secondary amine group of formula —NH— and primary amine group of formula —NH₂ [monomer (FN)], and
ε-caprolactam (or derivatives thereof); said branched polyamide possessing a concentration of amine end groups (AEG) and a concentration of carboxylic end groups (CEG) such that the difference AEG-CEG is of at least 100 meq/kg [polyamide (B)]; and
from 0.01 to 3.5% wt of at least one thermal stabilizer [stabilizer (S)].

While this polyamide composition demonstrates an excellent resistance to heat ageing, for certain applications there may still be a need for improving its mechanical durability and fatigue properties.

The aim of the invention is therefore to provide polyamide compositions, which have excellent heat ageing properties and improved fatigue properties than the known compositions, thereby providing for the possibility to make moulded articles that can be used at higher continuous use temperatures than the moulded articles prepared with the known compositions and which possess outstanding mechanical behaviour during usage at high temperature.

The inventors have now found that by the incorporation in compounds based on polyamides a well defined amount of a particular branched polyamide comprising a significant amount of amine end groups in excess over carboxylic acid end group is effective in delivering outstanding synergetic heat aging stability effect, in particular delivering outstanding retention of mechanical properties even after long term exposure to temperatures as high as 200° C., while simultaneously providing excellent fatigue properties e.g. in conditions of pressure pulsations.

### SUMMARY OF THE INVENTION

The invention thus pertain to a polyamide composition [composition (C)] comprising:
from 0 to 30% wt of at least one polyamide [polyamide (A)];
from above 30 to 99.99% wt of at least one branched polyamide different from polyamide (A), said branched polyamide comprising recurring units derived from polycondensation of a mixture [mixture (B)] comprising:
(i) at least one polyamine monomer comprising at least three amine functional groups selected from the group consisting of secondary amine group of formula —NH— and primary amine group of formula —NH₂ [monomer (FN)], and
(ii) ε-caprolactam (or derivates thereof);
said branched polyamide possessing a concentration of amine end groups (AEG) and a concentration of carboxylic end groups (CEG) such that the difference AEG-CEG is of at least 80 meq/kg [polyamide (B)]; and
from 0.01 to 3.5% wt of at least one thermal stabilizer [stabilizer (S)],
optionally, from 0 to 60% wt of at least one filler [filler (F)];
optionally, from 0 to 30% wt of at least one impact modifying rubber [rubber (I)];
optionally, from 0 to 10% wt of other conventional additives, with above % wt being referred to the total weight of composition (C).

The inventors have surprisingly found that the simultaneous incorporation of above detailed amounts of a thermal stabilizer and substantially amine-terminated branched polyamide is effective in unexpectedly delivering outstanding heat aging stability, improving heat aging performances at temperatures as high as 200° C., ensuring outstanding retention of mechanical properties, with substantially better performances over polyamide compounds comprising only a thermal stabilizer, or lower amount of branched polyamide.

In preferred embodiments, the polyamide compositions of the invention comprise:
from 0 to 30% wt of at least one polyamide [polyamide (A)];
from above 30 to 99.99% wt of at least one branched polyamide different from polyamide (A), said branched polyamide comprising recurring units derived from polycondensation of a mixture [mixture (B)] comprising:
   at least one trifunctional or tetrafunctional polyamine monomer comprising three or four amine functional groups selected from the group consisting of secondary amine group of formula —NH— and primary amine group of formula —NH₂ [monomer (FN)], and
   ε-caprolactam (or derivates thereof);
wherein,
when the monomer (FN) is a trifunctional polyamine monomer, said monomer (FN) is used in an amount such that the molar ratio monomer (FN)/ε-caprolactam (or derivatives thereof) is of at least 0.002 and of at most 0.030, and
when the monomer (FN) is a tetrafunctional polyamine monomer, said monomer (FN) is used in an amount such that the molar ratio monomer (FN)/ε-caprolactam (or derivatives thereof) is of at least 0.001 and of at most 0.030;
said branched polyamide possessing a concentration of amine end groups (AEG) and a concentration of carboxylic end groups (CEG) such that the difference AEG-CEG is of at least 100 meq/kg and of at most 300 meq/kg [polyamide (B)]; and
   from 0.01 to 3.5 wt of at least one thermal stabilizer [stabilizer (S)],
   optionally, from 0 to 60% wt of at least one filler [filler(F)];
   optionally, from 0 to 30% wt of at least one impact modifying rubber [rubber (I)];
   optionally, from 0 to 30% wt of other conventional additives, with above % wt being referred to the total weight of composition (C).

### DETAILED DESCRIPTION

In the present description, wherein an element or composition is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components.

The term “comprising” includes “consisting essentially of” and “consisting of”.

The sign “%” or “% wt” refers to “weight percent” unless specifically stated otherwise.

In the present specification, the description of a range of values for a variable, defined by a bottom limit, or a top limit, or by a bottom limit and a top limit, also comprises the embodiments in which the variable is chosen, respectively, within the value range: excluding the bottom limit, or excluding the top limit, or excluding the bottom limit and the top limit.

In the present specification, where an element or composition is said to be included in and/or selected from a list of recited elements or components, which should be understood that in related embodiments explicitly contemplated here, the element or component can also be any one of the individual recited elements or components, or can also be selected from a group consisting of any two or more of the explicitly listed elements or components.

For example, where in an embodiment the choice of an element from a group of elements is described, the following elements are also explicitly described:
the choice of two or more elements from the group,
the choice of an element from a subgroup of elements consisting of a group of elements from which one or more elements have been removed.

The use of the singular “a” or “one” herein includes the plural unless specifically stated otherwise.

In addition, if the term “about” is used before a quantitative value, the present teachings also include the specific quantitative value itself, unless specifically stated otherwise. As used herein the term “about” refers to a ±10% variation from the nominal value unless specifically stated otherwise.

The Polyamide (A)

The expression “polyamide (A)” is intended to denote any polymer which comprises recurring units which are derived:
from the polycondensation reaction of at least one dicarboxylic acid component (or derivative thereof) and at least one diamine component (or derivative thereof), and/or
from the polycondensation reaction of at least one aminocarboxylic acid and/or at least one lactam.

In addition to said recurring units, the polyamide (A) may comprise recurring units derived from diols, polyhydric alcohols, or other functional compounds including heteroatoms, such as O, P, S.

In certain preferred embodiments, the polyamide (A) of the present invention comprises at least 50 mol %, preferably at least 60 mol %, more preferably at least 70 mol %, still more preferably at least 80 mol % and most preferably at least 90 mol % of such recurring units. Excellent results were obtained when the polyamide (A) essentially consisted of said recurring units, being understood that minor amount (e.g. below 0.5% moles) of recurring units derived from other monomers (e.g. polyfunctional monomers) might still be present without this altering the thermal performances of the polyamide (A).

More precisely, polyamide (A) may be obtained by condensation reaction of at least one mixture selected from:
mixtures (M1) comprising at least a diacid [acid (DA)] (or derivative thereof) and at least a diamine [amine (NN)] (or derivative thereof);
mixtures (M2) comprising at least a lactam [lactam (L)];
mixtures (M3) comprising at least an aminocarboxylic acid [aminoacid (AN)]; and
combinations thereof.

Acid (DA) derivatives include notably salts, anhydrides, esters and acid halides, able to form amide groups; similarly, amine (NN) derivatives include notably salts thereof, equally able to form amide groups.

Said acid (DA) can be an aromatic dicarboxylic acid comprising two reactive carboxylic acid groups [acid (AR)] or an aliphatic or cycloaliphatic dicarboxylic acid comprising two reactive carboxylic acid groups [acid (AL)]. For the purpose of the present invention, a dicarboxylic acid is considered as “aromatic” when it comprises one or more than one aromatic group.

Non limitative examples of acids (AR) are notably phthalic acids, including isophthalic acid (IA), and terephthalic acid (TA), 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, naphthalene dicarboxylic acids, including 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid, 1,2-, 1,3- or 1,4-cyclohexane dicarboxylic acid.

Among acids (AL), mention can be notably made of oxalic acid (HOOC—COOH), malonic acid (HOOC—CH₂—COOH), succinic acid [HOOC—(CH₂)₂.—COOH], glutaric acid [HOOC—(CH₂)₃—COON], 2,2-dimethyl-glutaric acid [HOOC—C(CH₃)₂—(CH₂)₂-00011], adipic acid [HOOC—(CH₂)₄—COOH], 2,4,4-trimethyl-adipic acid [HOOC—CH(CH₃)—CH₂—C(CH₃)₂— CH₂—COOH], pimelic acid [HOOC—(CH₂)_{5—}COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecanedioic acid [HOOC—(CH₂)₁₀—COOH], tetradecanedioic acid [HOOC—(CH₂)₁₂—COOH], octadecanedioic acid [HOOC—(CH₂)₁₆—COOH].

Preferably, the acid (DA) used for the manufacture of the polyamide (A) will be an acid (AL), as above detailed, possibly in combination with a minor amount of an acid (AR), as above detailed.

The amine (NN) is generally selected from the group consisting of aliphatic and cycloaliphatic alkylene-diamines, aromatic diamines and mixtures thereof.

Said aliphatic alkylene-diamines are typically aliphatic alkylene diamines having 2 to 18 carbon atoms.

Said cycloaliphatic alkylene-diamines are typically cycloaliphatic alkylene diamines having 5 to 18 carbon atoms.

Said aliphatic alkylene diamine is advantageously selected from the group consisting of 1,2-diaminoethane, 1,2-diaminopropane, propylene-1,3-diamine, 1,3-diaminobutane, 1,4-diaminobutane, 1,5-diaminopentane, 1,5-diamino-2-methyl-pentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,8-diamino-2-methyloctane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2-dimethylheptane, 1,10-diaminodecane, 1,8-diamino-1,3-dimethyloctane, 1,8-diamino-1,4-dimethyloctane, 1,8-diamino-2,4-dimethyloctane, 1,8-diamino-3,4-dimethyloctane, 1,8-diamino-4,5-dimethyloctane, 1,8-diamino-2,2-dimethyloctane, 1,8-diamino-3,3-dimethyloctane, 1,8-diamino-4,4-dimethyloctane, 1,6-diamino-2,4-diethylhexane, 1,9-diamino-5-methylnonane, 1,11-diaminoundecane, 1,12-diaminododecane, and 1,13-diaminotridecane.

The aliphatic alkylene diamine preferably comprises at least one diamine selected from the group consisting of 1,6-diaminohexane, 1,8-diamino-octane, 1,10-diaminodecane, 1,12-diaminododecane and mixtures thereof. More preferably, the aliphatic alkylene diamine comprises at least one diamine selected from the group consisting of 1,6-diaminohexane, 1,10-diaminodecane and mixtures thereof. Examples of cycloaliphatic diamines are isophorone diamine, 1,2-, 1,3-, 1,4-diamino cyclohexane, 4,4′-diamino dicyclohexyl methane, and (4,4′-bis(aminocyclohexyl)methane.

The aromatic diamine is preferably selected from the group consisting of meta-xylylene diamine, and para-xylylene diamine.

Preferably, the amine (NN) used for the manufacture of the polyamide (A) will be an aliphatic alkylene diamine, as above detailed, possibly in combination with a minor amount of an aromatic diamine, as above detailed.

Preferred mixtures (M1) are:
mixtures of adipic acid and 1,6-diaminohexane;
mixtures of adipic acid, terephthalic acid and 1,6-diaminohexane;
mixtures of sebacic acid and 1,6-diaminohexane,
mixtures of terephthalic acid and 1,10-diaminodecane,
mixtures of adipic acid, terephthalic acid and 1,10-diaminodecane,
mixtures of adipic acid and 1,10-diaminodecane.

Lactam (L) suitable for use for the manufacture of polyamide (A) can be any of β-lactam or ε-caprolactam.

Preferred mixture (M2) comprises ε-caprolactam.

Aminoacid (AN) suitable for use for the manufacture of polyamide (A) can be selected from the group consisting of 6-amino-hexanoic acid, 9-aminononanoic acid, 10-aminodecanoic acid, 11-aminoundecanoic acid, 12-aminododecanoic acid.

It is still within the scope of the invention the addition to any of mixtures (M1), (M2), (M3) and their combination of one or more than one polyfunctional acid/amine monomers comprising more than two carboxylic acid and amine groups, e.g. polycarboxylic acids having three or more carboxylic acid groups, polyamines having three or more amine groups, polyfunctional diacid including two carboxylic groups and one or more amine groups, polyfunctional diamines including two amine groups and one or more carboxylic acid groups. Incorporation of said polyfunctional acid/amine monomers generally leads to branched structures, star-like or tree-like, such as those notably described in WO 97/24388 and in WO 99/64496.

It is also further understood that one or more than one end capping agent [agent (M)] can be added to any of mixtures (M1), (M2), (M3), and their combinations for the manufacture of polyamide (A), without this departing from the scope of the invention. The agent (M) is generally selected from the group consisting of an acid comprising only one reactive carboxylic acid group [acid (MA)] and an amine comprising only one reactive amine group [agent (MN)].

Acid (MA) is preferably selected from the group consisting of acetic acid, propionic acid, butyric acid, valeric acid, caproic acid, caprylic acid, lauric acid, stearic acid, cyclohexanecarboxylic acid, benzoic acid, preferably from acetic acid and benzoic acid.

Amine (MN) is preferably selected from the group consisting of methylamine, ethylamine, butylamine, hexylamine, octylamine, benzylamine, dodecylamine, cyclohexylamine.

Said polyamide (A) generally comprises at least 50% moles of recurring units of any of formula (I) or formula (II) [recurring units (R_{PA})] (with respect to the total moles of recurring units of polyamide (A)):

formula (I): —NH—R¹—CO—
formula (II): —NH—R²—NH—CO—R³—CO—,
wherein:
R′, equal to or different from each other at each occurrence, is a divalent hydrocarbon group having from 3 to 17 carbon atoms;
R², equal to or different from each other at each occurrence, is a divalent hydrocarbon group having from 2 to 18 carbon atoms; and
R³, equal to or different from each other at each occurrence, is a bond or a divalent hydrocarbon group having from 1 to 16 carbon atoms.

The polyamide (A) composition is preferably an aliphatic polyamide, that is to say that R′, R² and R³ are aliphatic group.

Exemplary recurring units (R_{PA}) of the polyamide (A) are notably:

(j) —NH—(CH₂)₅—00-, i.e. recurring units which can be notably obtained via polycondensation reaction of ε-caprolactam [recurring units (R₆)];
(jj) —NH—(CH₂)₈—00-, i.e. recurring units which can be notably obtained via polycondensation reaction of 9-aminononanoic acid [recurring units (R₉)];
(jjj) —NH—(CH₂)₉—00-, i.e. recurring units which can be notably obtained via polycondensation reaction of 10-aminodecanoic acid [recurring units (R₁₀)];
(jv) —NH—(CH₂)₁₀—00-, i.e. recurring units which can be notably obtained via polycondensation reaction of 11-aminoundecanoic acid [recurring units (R₁₁)];
(v) —NH—(CH₂)₁₁—00-, i.e. recurring units which can be notably obtained via polycondensation reaction of laurolactam [recurring units (R₁₂)];
(vj) —NH—(CH₂)₆—NH—CO—(CH₂)₄—00-, i.e. recurring units which can be notably obtained via polycondensation reaction of hexamethylene diamine and adipic acid [recurring units (R_{6,6})];
(vjj) —NH—(CH₂)₆—NH—CO—(CH₂)₁₀—00-, i.e. recurring units which can be notably obtained via polycondensation reaction of hexamethylene diamine and dodecanedioic acid [recurring units (R_{6,12})];
(vjjj) —NH—(CH₂)₆—NH—CO—(CH₂)₁₂—00-, i.e. recurring units which can be notably obtained via polycondensation reaction of hexamethylene diamine and tetradecanedioic acid [recurring units (R_{6,14})];
(jx) —NH—(CH₂)₁₀—NH—CO—(CH₂)₁₀—00-, i.e. recurring units which can be notably obtained via polycondensation reaction of decamethylene diamine and dodecanedioic acid [recurring units (R_{10,12})];
(x) —NH—(CH₂)₆—NH—CO—(CH₂)₇—CO—, i.e. recurring units which can be notably obtained via polycondensation reaction of hexamethylene diamine and azelaic acid (otherwise known as nonanedioic acid) [recurring units (R_{6,9})];
(xj) —NH—(CH₂)₁₂—NH—CO—(CH₂)₁₀—00-, i.e. recurring units which can be notably obtained via polycondensation reaction of dodecamethylene diamine and dodecanedioic acid [recurring units (R_{12,12})];

(xjj) —NH—(CH₂)₁₀—NH—CO—(CH₂)₈—CO—, i.e. recurring units which can be notably obtained via polycondensation reaction of decamethylene diamine and decanedioic acid [recurring units (R_{10,10})];

(xjjj) —NH—(CH₂)₄—NH—CO—(CH2)_{4—CO—, i.e. recurring units which can be notably obtained via polycondensation reaction of} 1,4-butanediamine and adipic acid [recurring units (R_{4,6})];
(xjv) —NH—(CH₂)₄—NH—CO—(CH2)_{8—CO—, i.e. recurring units which can be notably obtained via polycondensation reaction of} 1,4-butanediamine and sebacic acid [recurring units (R₄,0],
(xv) —HN—(CH₂)₆—NH—CO—(CH₂)₈—CO—, i.e. recurring units which can be notably obtained via polycondensation reaction of 1,6-hexamethylenediamine and sebacic acid [recurring units (R_{6,1}0];
(xvi) —HN—(CH₂)₁₀—NH—CO—(CH₂)₄—CO—, i.e. recurring units which can be notably obtained via polycondensation reaction of 1,10-decamethylenediamine and adipic acid [recurring units (R_{10,6})].

More than 50% moles, preferably more than 60% moles, even more preferably more than 70% moles of recurring units of the polyamide (A) are recurring units (R_{PA}), as above detailed.

Recurring units (R_{PA}) of the polyamide (A) may be all the same, so that the polyamide (A) is a homopolyamide, or may be of different types, so that the polyamide (A) is a co-polyamide.

According to certain preferred embodiments, polyamide (A) consists essentially of recurring units (R_{6,6}), as above detailed, that is to say polyamide (A) is a homo-polyamide PA66, being understood that end-chain, defects and other irregularities can be present in the polyamide (A) chain, without this affecting the properties thereof.

End groups of polyamide (A) can be of any type, including non-functional (end-capped) end groups, carboxylic acid end groups (CEG) and amine end groups (AEG).

It is nevertheless generally understood that according to preferred embodiments, polyamide (A) comprises a concentration of carboxylic acid end groups exceeding concentration of amine end groups.

To this aim, polyamide (A) can be preferably manufactured by polycondensation reaction in the presence of an excess of carboxylic acid groups in the monomers mixture, this excess being generally under the form of the use of an excess of at least one carboxylic acid comprising two or more than two carboxylic acid groups, preferably more than two.

The composition (C) will generally comprise a maximum of 30% wt, preferably less than 25% wt, more preferably less than 20% wt, even more preferably less than 15% wt, even more preferably less than 10% wt and most preferably less than 5% wt of polyamide (A) as above detailed, with respect to the total weight of the composition (C).

The Polyamide (B)

As said, the composition (C) comprises from above 30% wt (preferably above 40% wt, above 50% wt, above 60% wt, above 70% wt, above 80% wt, or above 90% wt) to 99.99% wt of at least one branched polyamide different from polyamide (A), said branched polyamide comprising recurring units derived from polycondensation of a mixture [mixture (B)] comprising:
at least one monomer (FN), as above defined, and
ε-caprolactam (or derivatives thereof);
said branched polyamide possessing a AEG and a CEG such that the difference AEG-CEG is of at least 80 meq/kg [polyamide (B)].

In a preferred embodiment the weight percentage of polyamide (B) is at least 70% wt, preferably at least 75% wt, more preferably at least 80% wt and even more preferably at least 90% wt, such as 100% wt relative to the total weight of polyamide (A) and polyamide (B) in composition (C).

The monomer (FN) is preferably a trifunctional polyamine monomer comprising three amine groups, as detailed above, or a tetrafunctional polyamine monomer comprising four amine groups, as detailed above.

As examples of monomers (FN), mention can be made of tris(aminoalkyl)amines, such as tris(2-aminoethyl)amine (TREN); polyoxyalkylenetriamines, such as for example Jeffamine T (R) from Huntsman, including Jeffamine T403 (R) (polyoxypropylenetriamine); polyalkylenepolyamines such as polyethyleneimine, which may advantageously have variable molecular weight, 1,8-diamino-4-aminomethyl-octane (TAN) and dialkylenetriamines, such as diethylenetriamine (DETA), bis(hexamethylene)triamine (BHT), and cyclohexane-1,3,5-triamine, and 2,2,6,6-tetrakis (2-aminoethyl)cyclohexanone.

Preferred polyfunctional monomers are bis(hexamethylene)triamine (BHT), tris(2-aminoethyl)amine (TREN), 1,8-diamino-4-aminomethyl-octane (TAN) and combinations thereof.

The expression ‘derivative thereof’ when used in combination with the expression ‘ε-caprolactam’ is intended to denote whichever derivative which is susceptible of reacting in polycondensation conditions to yield an amide bond. Examples of amide-forming derivatives include the corresponding amino-acid linear compound, monoalkyl esters, such as a mono-methyl, ethyl or propyl ester, of the same; a mono-aryl ester thereof; a mono-acid halide thereof; a mono-acid amide thereof, a mono-carboxylate salt and a mono-ammonium salt thereof. Examples of such derivatives are aminoundecanoic acid (PA11), aminododecanoic acid (PA12) and lauryl lactam, and copolymers thereof.

It is nevertheless generally understood that ε-caprolactam is preferably used as such in the manufacture of polymer (B).

The amount of monomer (FN) is not particularly limited, provided it can notably contribute to deliver the appropriate AEG and CEG, such that the AEG-CEG value is within the claimed boundaries. The skilled in the art will determine the required amount according to routine experiments, taking notably into account the number of amine groups of the monomer (FN) and the final molecular properties which are sought for polymer (B).

It is nevertheless generally understood that the monomer (FN) is used in an amount such that the molar ratio monomer (FN)/ε-caprolactam (or derivatives thereof) is of at least 0.001 and/or of at most 0.1, preferably of at most 0.040.

When the monomer (FN) is a trifunctional polyamine monomer, said monomer (FN) may be used in an amount such that the molar ratio monomer

(FN)/ε-caprolactam (or derivatives thereof) is of at least 0.002, preferably at least 0.003, more preferably at least 0.004 and/or of at most 0.040, more preferably of at most 0.030, even more preferably of at most 0.020.

When the monomer (FN) is a tetrafunctional polyamine monomer, said monomer (FN) is used in an amount such that the molar ratio monomer (FN)/c-caprolactam (or derivatives thereof) is of at least 0.001, preferably at least 0.002, and/or of at most 0.003 and/or at most 0.030, preferably of at most 0.020, more preferably of at most 0.015.

Particularly preferred are molar ratios monomer (FN)/ε-caprolactam (or derivatives thereof) in the range of from 0.002 to 0.030 for a trifunctional polyamine monomer and from 0.001 to 0.030 for a tetrafunctional polyamine monomer.

The mixture (B) leading by polycondensation to the polymer (B) can additionally comprise at least one diacid [acid (DA)], as above detailed for polymer (A) and/or at least one diamine [amine (NN)], as above detailed for polymer (A). Preferably, the mixture (B) is free from any amine (NN) as above detailed.

Preferred embodiments are those wherein said mixture (B) comprises at least one acid (DA), preferably adipic acid, optionally in combination with at least one said amine (NN), being nevertheless understood that mixture (B) is preferably free from amine (NN).

Without being bound by any theory, the inventors are of the opinion that the said acid (DA) in said mixture (B) can be beneficial for modulating melt viscosity of the polymer (B), which will be hence more easily recovered in molten state from the polymerization reactor and more easily processed in subsequent compounding.

Acid (DA) used in mixture (B) can be an acid (AL) or an acid (AR), as above detailed. Preferably, the acid (DA) used in mixture (B) will be an acid (AL), as above detailed, possibly in combination with minor amount of an acid (AR), as above detailed. Best results have been obtained when the mixture (B) comprised adipic acid, as acid (DA).

When present in the mixture (B) for the manufacture of polyamide (B), the acid (DA) may be used in an amount such that the molar ratio acid (DA)/monomer (FN) does not exceed the boundary 0.44+1/x, wherein x is the number of said amine groups in the monomer (FN).

Hence, when the monomer (FN) is a trifunctional polyamine monomer comprising three said amine groups, the molar ratio acid (DA)/monomer (FN) preferably does not exceed the boundary 0.44+⅓, i.e. 0.7733.

Minimum amount of acid (DA) is not particularly critical, and will be preferably selected by one of ordinary skills in the art as a function of target molecular weight, i.e. enabling obtaining polymer (B) with a number averaged molecular weight of at least 10000 g/mol.

It is further understood that, when present, the acid (DA) will be present in an amount such that the total number of carboxylic groups of the acid (DA) is less than the total number of the amine groups of the monomer (FN), and more precisely such that the difference AEG-CEG is of at least 80 meq/kg.

Polymerization of mixture (B) leading to polymer (B) can be realized following standard techniques known in the art for the manufacture of PA6 and/or PA66; such techniques might involve notably continuous polymerization processes or discontinuous polymerization processes.

In polymer (B), the difference AEG-CEG is of advantageously at least 100 meq/kg. The difference AEG-CEG preferably is of at most 300 meq/kg, more preferably of at most 200 meq/kg. A preferred range for the difference AEG-CEG is 80 meq/kg to 300 meq/kg, more preferred from 100 meq/kg to 300 meq/kg. Polymer (B) is advantageously semi-crystalline, that is to say, it possesses a distinguishable melting point. Polymer (B) advantageously possesses a melting point comprised in the range of from 150 to 250° C.

Polymer (B) advantageously possesses a melt viscosity when measured at 250° C., at a shear rate of 100 s⁻¹ of 10 to 5000 Pa×s.

Polymer (B) advantageously possesses a number averaged molecular weight of at least 10000 g/mol, preferably of at least 12000 g/mol, more preferably of at least 14000 g/mol.

Polymer (B) advantageously has a dispersibility (IP) of at most 5, preferably of at most 4, more preferably of at most 3.

The number averaged molecular weight (Mn) and the dispersity (IP) are determined by the equation (I) and (II):

$$Mn = ( 1 + \frac{R}{1 - R} ) . \frac{{10}^{6}}{[ Co + CEG ]} \qquad ( I )$$

$$IP = ( 1 + \frac{R}{1 - R} ) . ( 2 - {f ( f - 1 )}^{2} {( \frac{Co}{f . Co + CEG} )}^{2} + ( f - 1 ) . ( f - 2 ) . \frac{Co}{f . Co + CEG} ) \qquad ( II )$$

with R, the molar ratio acid (DA)/monomer (FN); Co and CEG, respectively the concentration of monomer (FN) and carboxylic end groups in the polymer (B) in meq/kg; f the functionality of the monomer (FN).

The Thermal Stabilizers

The composition (C) also comprises one or more than one heat stabilizer or anti-oxidant [stabilizer (S)], in above recited amount.

One or more than one stabilizer (S) can be used in the composition (C) of the present invention.

Thermal stabilizers (S) well known in the art for the thermal stabilization of polyamides can be effectively used.

Stabilizers (S) to be used in the composition (C) are generally selected from the group consisting of copper-containing stabilizers, hindered amine compounds, hindered phenol compounds, polyhydric alcohols (PHA), and phosphorous compounds.

The Copper-Containing Stabilizer

Stabilizer (S) preferably comprises at least one copper-containing stabilizer. While these copper containing stabilizers can be used alone in the composition (C), it may also be possible to use the same in combination with one or more of above mentioned recited alternative stabilizers (S).

Preferred embodiments are nevertheless those wherein the copper-containing stabilizer is used alone, that is to say that the stabilizer (S) is a copper-containing stabilizer.

Copper-containing stabilizers useful in the practice of the invention may be characterized as comprising a copper compound [compound (Cu)] and an alkali metal halide [halide (M)]. More particularly, the copper-containing stabilizer will consist essentially of a copper compound [compound (Cu)] selected from the group consisting of copper (I) oxide, copper (II) oxide, copper (I) salt, for example cuprous acetate, cuprous stearate, a cuprous organic complex compound such as copper acetylacetonate, a cuprous halide or the like; and an alkali metal halide [halide (M)]. According to certain preferred embodiments, the copper-containing stabilizer will consist essentially of a copper halide selected from copper iodide and copper bromide and the alkali metal halide will preferably be selected from the iodides and bromides of lithium, sodium and potassium.

A particularly preferred combination is the combination of CuI and KI. Another very advantageous combination is the mixture of Cu₂O and KBr.

The copper-containing stabilizer will preferably consists of a copper compound [compound (Cu)], preferably with Copper in oxidation state+I, and an alkali metal halide [halide (M)] wherein the atomic weight ratio Cu:halide, i.e. the weight ratio between the overall Copper content of the compound (Cu) and the overall halogen content of the halide (M) and possibly of the compound (Cu) (if this latter comprises halogen) is of 1:99 to 30:70, preferably 5:95 to 20:80. A weight ratio Cu:halide which has been found particularly effective is of about 0.15 (i.e. corresponding to about 13:87).

The combined weight of compound (Cu) and halide (M), i.e. of the copper-containing stabilizer, in the composition (C) will amount to from about 0.01 to about 3 wt %, preferably from about 0.02 to about 2.5% wt, more preferably from about 0.1 to about 1.5 wt %, based on the total weight of composition (C).

The amount of the compound (Cu) in the copper-containing stabilizer will generally be sufficient to provide a level of from about 25 to about 1000 ppm, preferably of about 50 to about 500 ppm, more preferably of about 75 to about 150 ppm of Copper in the composition (C).

The Hindered Amine Compound

The expression “hindered amine compound” is used according to its customary meaning in this field and generally intended to denote derivatives of 2,2,6,6-tetramethyl piperidine well known in the art (see for example: Plastics Additives Handbook, 5th ed., Hanser, 2001). The hindered amine compound of the composition according to the present invention may either be of low or high molecular weight.

The hindered amine compounds of low molecular weight have typically a molecular weight of at most 900, preferably at most 800, more preferably of at most 700, still more preferably at most 600 and most preferably of at most 500 g/mol.

Examples of low molecular weight hindered amine compounds are listed in Table 1 below:

TABLE 1

| Formula | |
|---|---|
| (a1) | 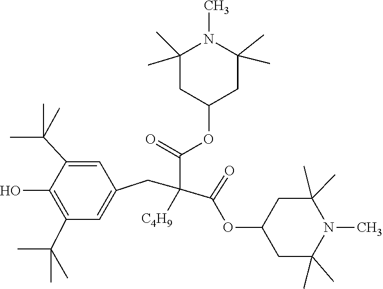 |
| (a2) | 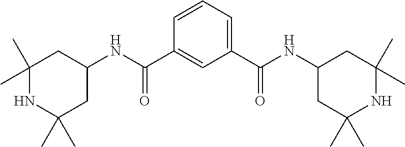 |
| (a3) | 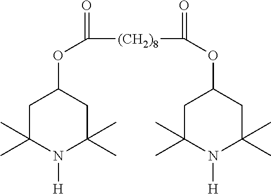 |
| (a4) | 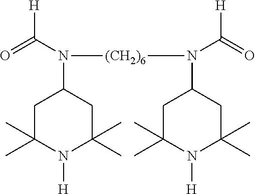 |
| (a5) | 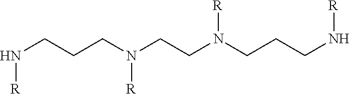 |
| | 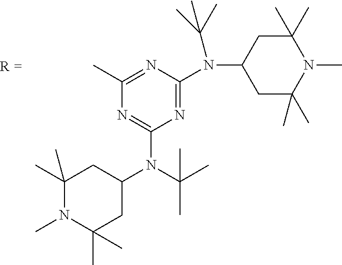 |
| (a6) | 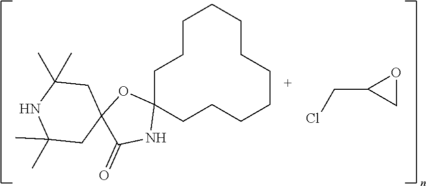 |
| (a7) | 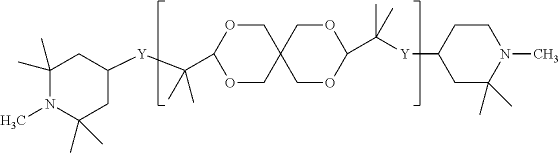 |
| | 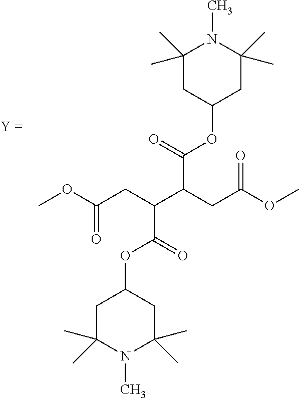 |
| (a8) | 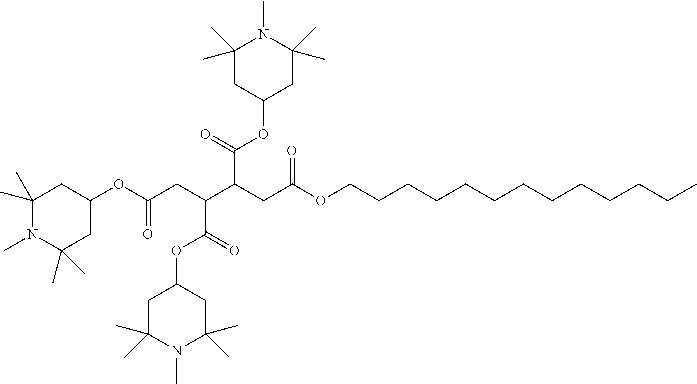 [SMILES: CCCCCCCCCCCCCOC(=O)CC(C(=O)OC1CC(C)(C)N(C)C(C)(C)C1)C(CC(=O)OC1CC(C)(C)N(C)C(C)(C)C1)C(=O)OC1CC(C)(C)N(C)C(C)(C)C1] |
| (a9) | 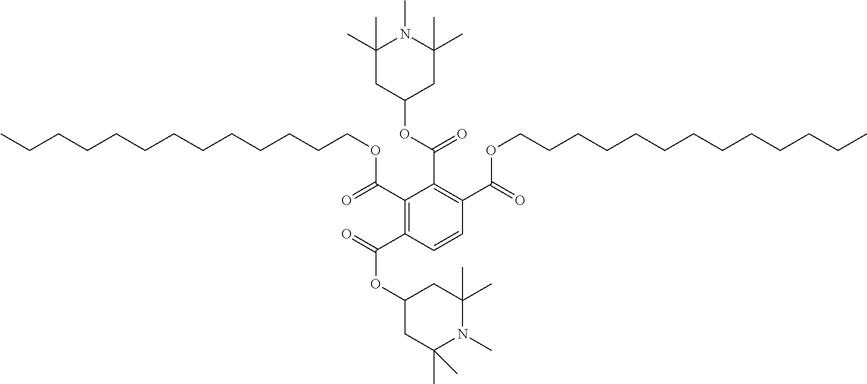 [SMILES: CCCCCCCCCCCCCOC(=O)c1ccc(C(=O)OC2CC(C)(C)N(C)C(C)(C)C2)c(C(=O)OCCCCCCCCCCCCC)c1C(=O)OC1CC(C)(C)N(C)C(C)(C)C1] |
| (a10) | 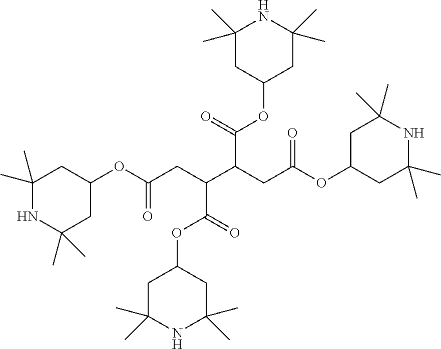 |
| (a11) | 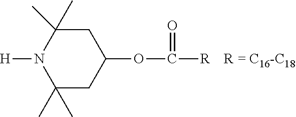 |
| (a12) | 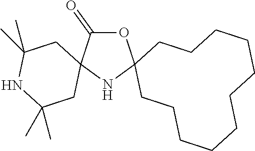 [SMILES: CC1(C)CC2(CC(C)(C)N1)NC1(CCCCCCCCCCC1)OC2=O] |

Among those low molecular weight compounds, the hindered amine is preferably selected from the group consisting of the ones corresponding to formula (a1), (a2), (all) and (a12). More preferably, the hindered amine is selected from the group consisting of the ones corresponding to formula (a1), (a2), and (a12). Still more preferably, the hindered amine is the one corresponding to formula (a2).

The hindered amine compounds of high molecular weight are typically polymeric and have typically a molecular weight of at least 1000, preferably at least 1100, more preferably of at least 1200, still more preferably at least 1300 and most preferably of at least 1400 g/mol.

Examples of high molecular weight hindered amine compounds are listed in Table 2 below:

TABLE 2

| Formula | |
|---|---|
| (b1) | 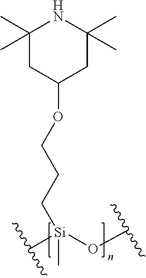 |
| (b2) | 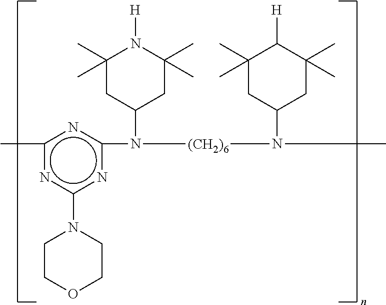 |
| (b3) | Butanedioc acid, dimethylester, polymer with 4-hydroxy- |
| | 2,2,6,6-tetramethyl-1-piperidine ethanol, commercially |
| | available notably as Tinuvin(R) 622 stabilizer from BASF |
| | 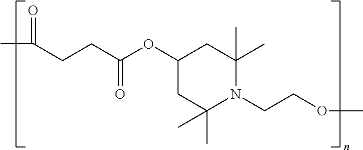 |
| (b4) | 1,6-Hexanediamine, N,N′-bis(2,2,6,6-tetramethyl-4- |
| | piperidinyl)-polymer with 2,4,6-trichloro-1,3,5-triazine, |
| | reaction products with N-butyl-1-butanamine and N-butyl- |
| | 2,2,6,6-tetramethyl-4-piperidinamine, commercially |
| | available notably as Chimassorb(R) 2020 stabilizer from |
| | BASF |
| | 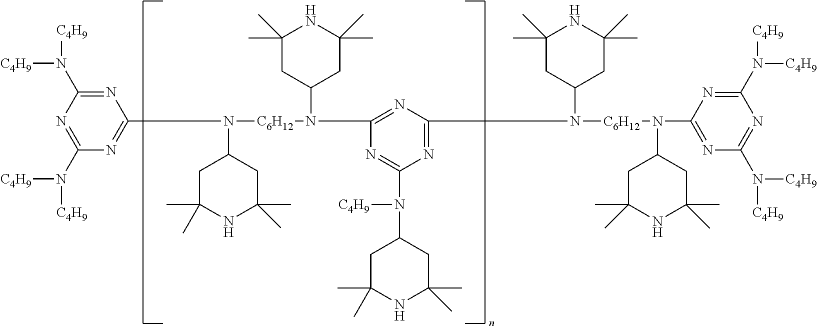 |
| (b5) | Poly[[6-[(1,1,3,3-tetramethylbutyl)amino]-1,3,5-triazine-2,4- |
| | diyl][(2,2,6,6-tetramethyl-4-piperidinyl)imino]-1,6- |
| | hexanediyl[(2,2,6,6-tetramethyl-4-piperidinyl)imino]]), |
| | commercially available notably as Chimassorb(R) |
| | 944 stabilizer from BASF |
| | 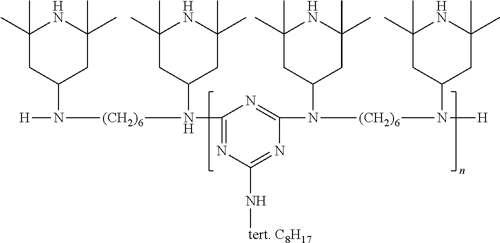 |
| (b6) | 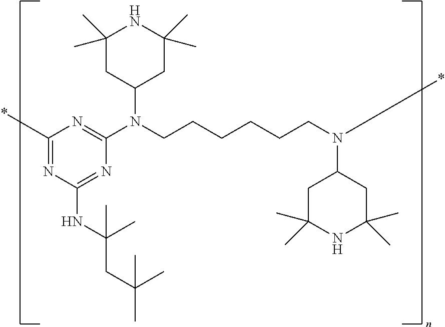 |

The “n” in the formulas (b1) to (b6) of Table 2 indicates the number of repeating units in the polymer and is usually an integral equal or greater than 4.

Among those high molecular weight compounds, the hindered amine is preferably selected from the group consisting of the ones corresponding to formula (b2) and (b5). More preferably, the high molecular weight hindered amine is the one corresponding to formula (b2).

If used, the hindered amine compound is typically present in an amount of advantageously at least 0.01 wt. %, more preferably at least 0.05 wt. %, still more preferably at least 0.1 wt. %, based on the total weight of the composition. Similarly, when present, the hindered amine compound is also typically present in an amount of advantageously at most 3.5 wt. %, preferably at most 3 wt. %, more preferably at most 2.5 wt. %, still more preferably at most 2.0 wt. %, even more preferably at most 0.8 wt. % and most preferably at most 0.6 wt. %, based on the total weight of the composition.

The Hindered Phenol Compound

The expression “hindered phenol compound” is used according to its customary meaning in this field and generally intended to denote derivatives of ortho-substituted phenol, especially (but not limited to) di-tert-butyl-phenol derivatives, well known in the art

Examples of hindered phenol compounds are listed in Table 3 below:

TABLE 3

| | |
|---|---|
| (d1) tetrakis(3-(3,5-di-tert-butyl-4- hydroxyphenyl)propionate), commercially available notably as Irganox ® 1010 stabilizer from BASF | 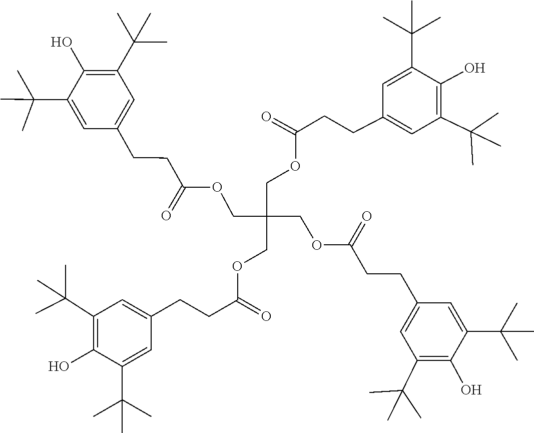 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O] |
| (d2) Thiodiethylene bis[3-(3,5-di-tert.-butyl-4- hydroxy-phenyl)propionate], commercially available notably as Irganox ® 1035 stabilizer from BASF | 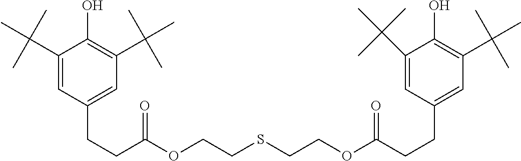 [SMILES: CC(C)(C)c1cc(CCC(=O)OCCSCCOC(=O)CCc2cc(C(C)(C)C)c(O)c(C(C)(C)C)c2)cc(C(C)(C)C)c1O] |
| (d3) Octadecyl-3-(3,5-di-tert.butyl-4- hydroxyphenyl)-propionate, commercially available notably as Irganox ® 1076 stabilizer from BASF | 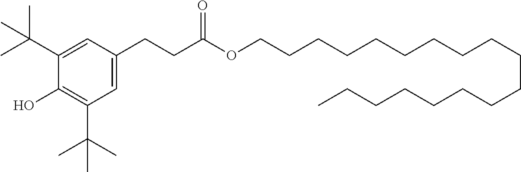 [SMILES: CCCCCCCCCCCCCCCCCCOC(=O)CCc1cc(C(C)(C)C)c(O)c(C(C)(C)C)c1] |
| (d4) N,N′-hexane-1,6-diylbis(3-(3,5-di-tert.- butyl-4-hydroxyphenylpropionamide)), commercially available notably as Irganox ® 1098 stabilizer from BASF | 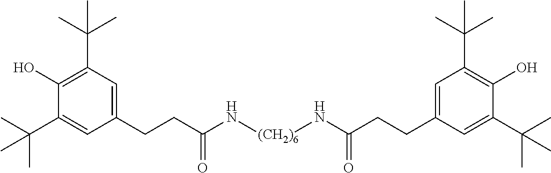 |
| (d5) 1,3,5-Trimethyl-2,4,6-tris(3,5-di-tert-butyl- 4-hydroxybenzyl)benzene, commercially available notably as Irganox ® 1330 stabilizer from BASF | 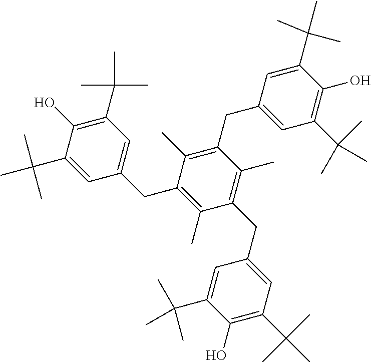 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1] |
| (d6) Benzenepropanoic acid, 3,5,-bis(1,1- dimethylethyl)-4-hydroxy-,C7-C9 branched alkyl esters, commercially available notably as Irganox ® 1135 stabilizer from BASF | 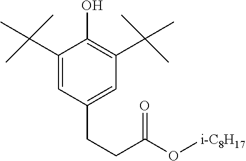 |
| (d7) Hexamethylene bis[3-(3,5-di-tert-butyl-4- hydroxyphenyl)propionate], commercially available notably as Irganox ® 259 stabilizer from BASF | 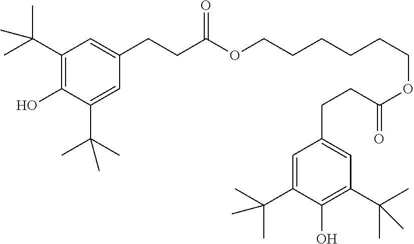 [SMILES: CC(C)(C)c1cc(CCC(=O)OCCCCCCOC(=O)CCc2cc(C(C)(C)C)c(O)c(C(C)(C)C)c2)cc(C(C)(C)C)c1O] |
| (d8) Tris(3,5-di-tert-butyl-4-hydroxybenzyl) isocyanurate, commercially available notably as Irganox ® 3114 stabilizer from BASF | 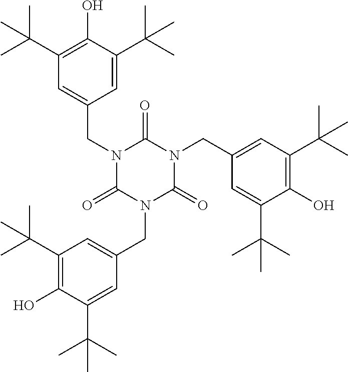 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O] |
| (d9) 2,6-di-tert-butyl-4-(4,6-bis(octylthio)-1,3,5- triazin-2-ylamino)phenol, commercially available notably as Irganox ® 565 stabilizer from BASF | 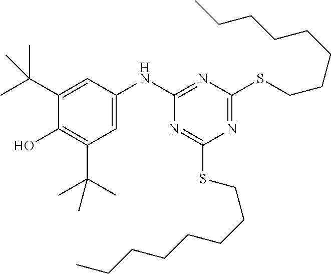 [SMILES: CCCCCCCCSc1nc(Nc2cc(C(C)(C)C)c(O)c(C(C)(C)C)c2)nc(SCCCCCCCC)n1] |
| (d10) commercially available notably as Irganox ® 1425 stabilizer from BASF | 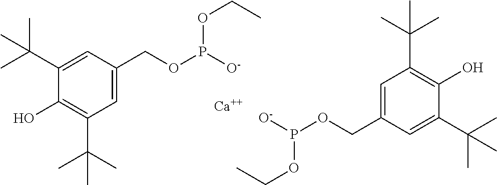 [SMILES: CCOP([O-])OCc1cc(C(C)(C)C)c(O)c(C(C)(C)C)c1 ; [Ca+2] ; CCOP([O-])OCc1cc(C(C)(C)C)c(O)c(C(C)(C)C)c1] |
| (d11) 2-Methyl-4,6- bis(octylsulfanylmethyl)phenol, commercially available notably as Irganox ® 1520 stabilizer from BASF | 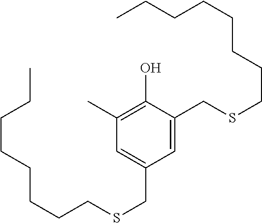 [SMILES: CCCCCCCCSCc1cc(C)c(O)c(CSCCCCCCCC)c1] |
| (d12) 2,4-Bis(dodecylthiomethyl)-6- methylphenol, commercially available notably as Irganox ® 1726 stabilizer from BASF | 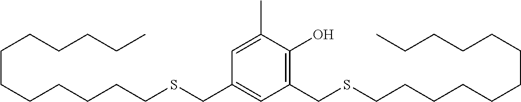 [SMILES: CCCCCCCCCCCCSCc1cc(C)c(O)c(CSCCCCCCCCCCCC)c1] |
| (d13) Triethylene glycol bis(3-tert-butyl-4- hydroxy-5-methylphenyl)propionate, commercially available notably as Irganox ® 245 stabilizer from BASF | 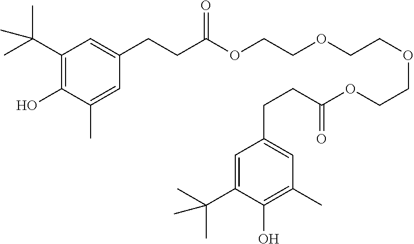 [SMILES: Cc1cc(CCC(=O)OCCOCCOCCOC(=O)CCc2cc(C)c(O)c(C(C)(C)C)c2)cc(C(C)(C)C)c1O] |

A hindered phenol compound which has been found particularly effective in the composition (C) is N,N′-hexane-1,6-diylbis(3-(3,5-di-tert.-butyl-4-hydroxyphenylpropionamide)) of formula (d4), as above specified.

If used, the hindered phenol compound is typically present in an amount of advantageously at least 0.01 wt. %, more preferably at least 0.05 wt. %, still more preferably at least 0.1 wt. %, based on the total weight of the composition.

Similarly, when present, the hindered phenol compound is also typically present in an amount of advantageously at most 3.5 wt. %, preferably at most 3 wt. %, more preferably at most 2.5 wt. %, still more preferably at most 2.0 wt. %, even more preferably at most 0.8 wt. % and most preferably at most 0.6 wt. %, based on the total weight of the composition.

The Polyhydric Alcohols

The stabilizer (S) may be at least one polyhydric alcohol (PHA).

The expression “polyhydric alcohol” and “PHA” is used within the context of the present invention for designating an organic compound containing three or more hydroxyl groups in the molecule. The PHA can be an aliphatic, cycloaliphatic, arylaliphatic or aromatic compound, and may comprise one or more than one heteroatoms, including N, S, O, halogen and/or P, and can comprise additional functional groups (other than hydroxyl groups) such as ether, amine, carboxylic acid, amide or ester groups.

According to preferred embodiments, when used as stabilizer (S), the PHA complies with formula R—(OH) (I) wherein:
n is an integer of 3 to 8, and preferably 4 to 8; and
R is a C₁-C₃₆ hydrocarbon radical.

Generally, hydroxyl groups of the PHA are bound to aliphatic carbon atoms; in other terms, the PHA is generally not a phenol-type compound.

Further, it is generally preferred for said hydroxyl group of not being sterically hindered. To this aim, the carbon atoms in alpha position to the aliphatic carbon bringing the hydroxyl group are generally free from sterically hindered substituents, and more specifically free from branched aliphatic groups.

PHA compounds particularly suitable for being used as stabilizer (S) within the frame of the present invention are notably:
triols, in particularly selected from the group consisting of glycerol, trimethylolpropane, trimethylolbutane, 2,3-di(2′-hydroxyethyl)-cyclohexan-1-ol, hexane-1,2,6-triol, 1,1,1-tris(hydroxymethyl)ethane, 3-(2′-hydroxyethoxy)propane-1,2-diol, 3-(2′-hydroxypropoxy)-propane-1,2-diol, 2-(2′-hydroxyethoxy)-hexane-1,2-diol, 6-(2′hydroxypropoxy)-hexane-1,2-diol, 1,1,1-tris-[(2′-hydroxyethoxy)-methylethane, 1,1,1-tris-[(2′-hydroxypropoxy)-methyl-propane, 1,1,1-tris-(4′-hydroxyphenyl)ethane, 1,1,1-tris-(hydroxyphenyl)-propane, 1,1,5-tris-(hydroxyphenyl)-3-methylpentane, trimethylolpropane ethoxylate, trimethylolpropane propoxylate, tris(hydroxymethyl)aminomethane, N-(2-Hydroxy-1,1-bis(hydroxymethyl)ethyl)glycine (also know as tricine), and salts thereof;
tetraols, in particularly selected from the group consisting of diglycerol, di(trimethylolpropane), pentaerythritol, 1,1,4-tris-(dihydroxyphenyl)-butane;
polyols comprising 5 hydroxyl groups, in particular triglycerol;
polyols comprising 6 hydroxyl groups, in particular dipentaerythritol;
polyols comprising 8 hydroxyl groups, in particular tripentaerythritol;
saccharide-type polyols, in particular selected from the group consisting of cyclodextrine, D-mannose, glucose, galactose, sucrose, fructose, arabinose, D-mannitol, D-sorbitol, D- or L- arabitol, xylitol, iditol, talitol, altritol, gulitol, erythrol, threitol, D-gulono-1,4-lactone.

PHA which have been found to provide particularly good results within the frame of the present invention are diglycerol, triglycerol, pentaerythritol, dipentaerythritol (DPE), tripentaerythritol (TPE) and di(trimethylolpropane), with dipentaerythritol (DPE) and tripentaerythritol (TPE) being preferred, and dipentaerythritol (DPE) particularly preferred.

It is further understood that said PHA may react with the polyamide (A) and/or the polyamide (B).

It is hence generally understood that, when the stabilizer is or comprises PHA, embodiments wherein at least a fraction of said PHA is bound to the polyamide (A) and/or to the polyamide (B) are still within the scope of the present invention.

According to these latter embodiments, the fraction of PHA which can be thus bound to the polyamide molecule is of at least 50% moles, preferably at least 70% moles, even more preferably at least 80% moles, with respect to the total moles of PHA used.

When used as stabilizer (S), the PHA is present in an amount of at least 0.1% wt, preferably of at least 0.5% wt, even more preferably at least 0.75% wt and of at most 3.5% wt, preferably of at most 3% wt, even more preferably of at most 2.5% wt, with respect to the weight of the polyamide (A).

When at least part of the PHA is chemically bound to the polyamide (A) and/or polyamide (B), it is acknowledged that the composition (C) will comprise, if any, non-chemically bonded PHA in an amount of less than 2% wt, preferably of less than 1.5% wt, more preferably of less than 1% wt, with respect to the total weight of the composition (C).

The Phosphorous Compound

The stabilizers (S) may be at least one phosphorous compound selected from the group consisting of an alkali or alkali earth metal hypophosphites, phosphite esters, phosphonites and mixtures thereof.

Sodium and calcium hypophosphites are preferred alkali or alkali earth metal hypophosphites.

A phosphite ester may be represented by the formula P(OR)₃, while a phosphonite may be represented by the formula P(OR)₂R, wherein each of R, can be the same or different and are typically independently selected from the group consisting of a C₁₋₂₀ alkyl, C₃₋₂₂ alkenyl, C₆₋₄₀ cycloalkyl, C₇₋₄₀ cycloalkylene, aryl, alkaryl or arylalkyl moiety.

Examples of phosphite esters are listed in the Table 4 below:

TABLE 4

| Formula | |
|---|---|
| (e1) | 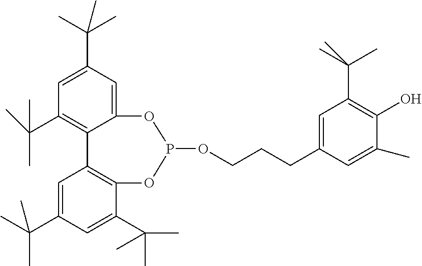 [SMILES: Cc1cc(CCCOp2oc3cc(C(C)(C)C)cc(C(C)(C)C)c3c3cc(C(C)(C)C)cc(C(C)(C)C)c3o2)cc(C(C)(C)C)c1O] |
| (e2) | 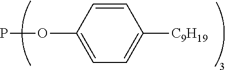 |
| (e3) | 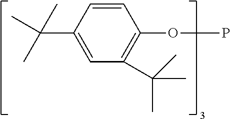 |
| (e4) | 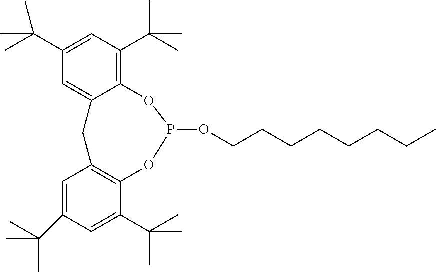 [SMILES: CCCCCCCCOP1Oc2c(cc(C(C)(C)C)cc2C(C)(C)C)Cc2cc(C(C)(C)C)cc(C(C)(C)C)c2O1] |
| (e5) | 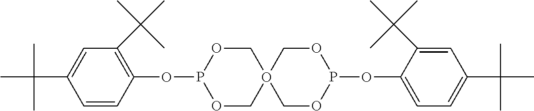 |
| (e6) | 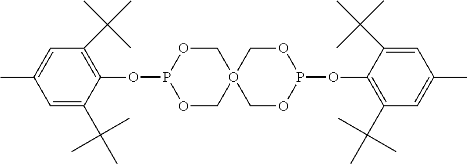 |
| (e7) | 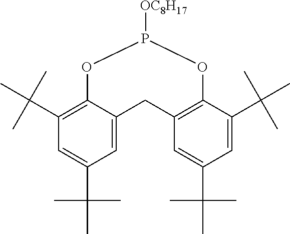 |
| (e8) | 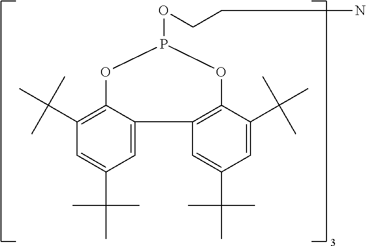 |
| (e9) | 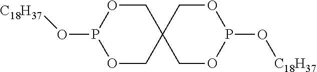 |
| (e10) | 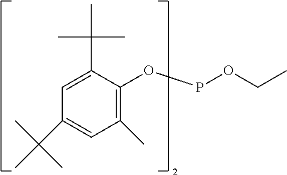 |
| (e11) | 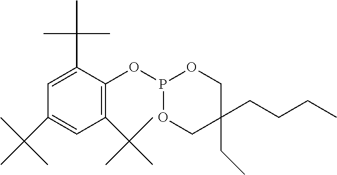 [SMILES: CCCCC1(CC)COP(Oc2c(C(C)(C)C)cc(C(C)(C)C)cc2C(C)(C)C)OC1] |
| (e12) | 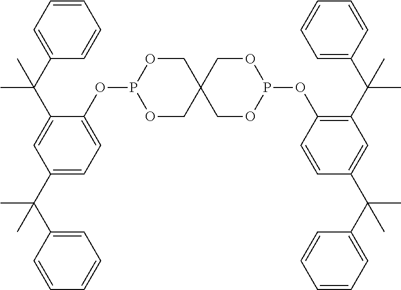 [SMILES: CC(C)(c1ccccc1)c1ccc(OP2OCC3(CO2)COP(Oc2ccc(C(C)(C)c4ccccc4)cc2C(C)(C)c2ccccc2)OC3)c(C(C)(C)c2ccccc2)c1] |

Examples of phosphonites are listed in the table 5 below:

TABLE 5

| Formula | Structure |
|---|---|
| (f1) | 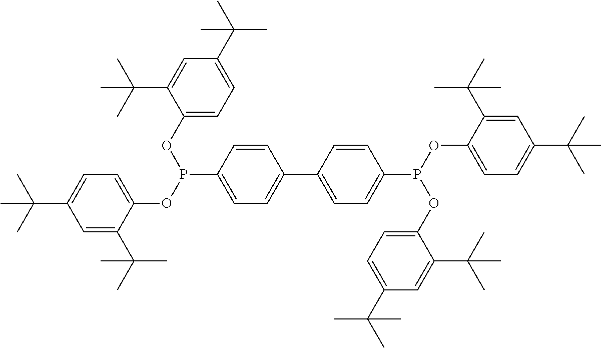 [SMILES: CC(C)(C)c1ccc(OP(Oc2ccc(C(C)(C)C)cc2C(C)(C)C)c2ccc(-c3ccc(P(Oc4ccc(C(C)(C)C)cc4C(C)(C)C)Oc4ccc(C(C)(C)C)cc4C(C)(C)C)cc3)cc2)c(C(C)(C)C)c1] |
| (f2) | 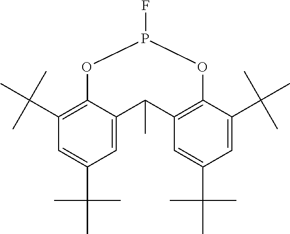 [SMILES: CC1c2cc(C(C)(C)C)cc(C(C)(C)C)c2OP(F)Oc2c1cc(C(C)(C)C)cc2C(C)(C)C] |

When used in the composition (C), the phosphorous compound is preferably present in an amount of at least 0.01 wt. %, more preferably at least 0.05 wt. %, based on the total weight of the composition.

The phosphorous compound is also preferably present in an amount of at most 1 wt. %, more preferably at most 0.5 wt. %, still more preferably at most 0.25 wt. %, based on the total weight of the composition.

The Filler (F)

The composition optionally comprises from 0 to 60% wt, preferably from 10 to 50% wt of one or more than one filler (F).

Said filler (F) can be any reinforcement agent, but it is preferably selected from the group consisting of calcium carbonate, glass fibers, glass flakes, glass beads, carbon fibers, talc, mica, wollastonite, calcined clay, kaolin, diatomite, magnesium sulphate, magnesium silicate, barium sulphate, titanium dioxide, sodium aluminium carbonate, barium ferrite, potassium titanate.

The filler (F), from morphology perspective, can be hence selected from fibrous fillers and particulate fillers.

Preferably, the filler is chosen from fibrous fillers. Among fibrous fillers, glass fibers are preferred; they include chopped strand A-, E-, C—, D-, S- and R-glass fibers. Glass fibers with circular and non-circular cross sections can be used. The expression ‘glass fibers with non-circular cross section’ is used herein according to its usual meaning, that is to say it is intended to refer to glass fibers having a cross section having a major axis lying perpendicular to longitudinal direction of the glass fiber and corresponding to the longest linear distance in the cross-section, and a minor axis, corresponding to the linear distance in cross-section in a direction perpendicular to the major axis. The non-circular cross section of the fiber may have a variety of shapes including cocoon-type shape, a rectangual shape, an elliptical shape, a polygonal shape, an oblong shape, without this list being exhaustive. The ratio of the length of the major axis to the minor axis is preferably between about 1.5:1 to about 6:1, more preferably between about 2:1 to about 5:1, still more preferably between about 3:1 to about 4:1.

In preferred embodiments, glass fibers, and more particularly, circular cross-section glass fibers will be used as filler (F).

The composition (C) will comprise preferably at least 15% wt, more preferably at least 20% wt of filler (F), as above detailed, with respect to the total weight of the composition (C).

Still, the composition (C) comprises usually at most 60% wt, preferably at most 55% wt, even more preferably at most 50% wt of filler (F), as above detailed, with respect to the total weight of the composition (C).

Particularly good results have been obtained when the composition (C) comprised from about 10 to about 40% wt of filler (F), as above detailed, with respect to the total weight of the composition (C).

Rubber (I) The composition (C) optionally comprises from 0 to 30% wt, preferably from 0 to 20% wt of at least one impact modifying rubber [rubber (I)].

Rubbers (I) suitable for use in the composition (C) generally comprise at least one functional group able to react with the polyamide (A), and more particularly with amine or carboxylic acid end groups of the polyamide (A) [functionalized rubber (IF)].

The functional group of the functionalized rubber (IF) is generally selected from carboxylic acid groups and derivatives thereof (including notably salts and esters); epoxy groups; anhydride groups, oxazoline groups, maleimide groups or mixture thereof.

The functionalized rubber (IF) may be an oligomer or polymer compound, wherein the functional groups can be incorporated by copolymerizing a functional monomer during polymerization of the impact modifier backbone or by grafting of a pre-formed polymer backbone.

Said functionalized rubbers (IF) generally comprise recurring units derived from at least one of the following monomers: ethylene; higher alpha olefins including propylene, butene, octene; dienes, including butadiene and isoprene; acrylates, styrene, acrylonitrile; (meth)acrylic acid and derivatives thereof, including esters; vinyl monomers, including vinyl acetate, and other vinyl esters. Other monomers may be equally comprised in the structure of the functionalized rubber (IF).

The polymer backbone of the functionalized rubber (IF) will generally be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MB S) type, or mixture of one or more of the above.

It is understood that in case no functional group is comprised in said polymer backbone, the functionalized rubber (IF) will further incorporate, by copolymerization or grafting, residues from functional monomers including any of carboxylic acid groups and derivatives thereof (including notably salts and esters); epoxy groups; anhydride groups, oxazoline groups, maleimide groups or mixture thereof. It is further envisioned that said functional monomers may be used for further modifying backbones which may already comprise a functional group.

Specific examples of functionalized rubbers (IF) are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene-maleimide copolymers grafted with maleic anhydride; SEBS copolymers grafted with maleic anhydride; styrene-acrylonitrile copolymers grafted with maleic anhydride; ABS copolymers grafted with maleic anhydride.

Functionalized rubbers (IF) which have been found particularly effective within the frame of the present invention are ethylene amorphous copolymers grafted with maleic anhydride.

When present, the amount of said rubber (I) is generally of at least 1% wt, preferably 2% wt, more preferably at least 3% wt, more preferably at least 4% wt, with respect to the total weight of the composition (C). Still, its amount is generally of at most 30% wt, preferably at most 15% wt, more preferably at most 10% wt, and even more preferably at most 8% wt, with respect to the total weight of the composition (C).

Other Ingredients

The composition (C) may also comprise other conventional additives commonly used in the art, including lubricants, plasticizers, colorants, pigments, antistatic agents, flame-retardant agents, nucleating agents, catalysts, and the like. When present, these ingredients are present in an amount of at most 30% wt, preferably at most 20% wt, more preferably of at most 10% wt, and even more preferably of at most 8% wt, with respect to the total weight of the composition (C). Typical amounts are depending of the specific conventional additive selected for incorporation in the composition (C) and will be selected by the skilled in the art according to common practice.

Manufacture of the Composition (C)

The invention further pertains to a method of making the composition (C) as above detailed, said method comprising melt-blending the polyamide (A), the polyamide (B), the stabilizer (S), and any other optional ingredient.

Any melt-blending method may be used for mixing polymeric ingredients and non-polymeric ingredients of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing filler presents a long physical shape (for example, a long glass fiber), drawing extrusion molding may be used to prepare a reinforced composition.

Use of the Composition (C)

The composition (C), as disclosed above, is useful in increasing long-term thermal stability at high temperatures and improving fatigue properties of molded or extruded articles made therefrom. The long-term heat stability of the articles can be assessed by exposure (air oven ageing) of 4 mm thick test samples at various test temperatures in an oven for various test periods of time. The oven test temperatures for the composition disclosed herein include 200° C. and up to 2000 hours test periods. The test samples, after air oven ageing, are tested for tensile modulus, tensile strength at break and elongation to break, according to ISO 527-2/1A test method; and compared with unexposed controls having identical composition and shape, that are as molded. The comparison with the as molded controls provides the retention of tensile strength and/or retention of elongation to break, and thus the various compositions can be assessed as to long-term heat stability performance.

The mechanical durability of articles made of the composition (C) can be assessed by a hot air pressure pulsated test as described in the examples below. In various embodiments the composition (C) has a 200° C./1000 hours retention of tensile strength of at least 60% and preferably at least 70%, based upon comparison with as molded non-exposed controls.

In another aspect, the present invention relates a use of the above disclosed composition (C) for high temperature applications.

In yet another aspect, the present invention relates to a method for manufacturing an article by shaping the composition (C) of the invention. Examples of articles are films, yarns, fibers, laminates, automotive parts or engine parts or electrical/electronics parts. By “shaping”, it is meant any shaping technique, such as for example extrusion, injection moulding, thermoform moulding, compression moulding or blow moulding. Preferably, the article is shaped by injection moulding or blow moulding.

The molded or extruded thermoplastic articles disclosed herein may have application in many vehicular components that meet one or more of the following requirements: high impact requirements; significant weight reduction (over conventional metals, for instance); resistance to high temperature; resistance to oil environment; resistance to chemical agents such as coolants; and noise reduction allowing more compact and integrated design. Specific molded or extruded thermoplastic articles are selected from the group consisting of charge air coolers (CAC); cylinder head covers (CHC); oil pans; engine cooling systems, including thermostat and heater housings and coolant pumps; exhaust systems including mufflers and housings for catalytic converters; air intake manifolds (AIM); and timing chain belt front covers. As an illustrative example of desired mechanical resistance against long-term high temperature exposure, a charge air cooler can be mentioned. A charge air cooler is a part of the radiator of a vehicle that improves engine combustion efficiency. Charge air coolers reduce the charge air temperature and increase the density of the air after compression in the turbocharger thus allowing more air to enter into the cylinders to improve engine efficiency. Since the temperature of the incoming air can be more than 200° C. when it enters the charge air cooler, it is required that this part be made out of a composition maintaining good mechanical properties under high temperatures for an extended period of time.

Should the disclosure of any patents, patent applications, and publications which are incorporated herein by reference conflict with the description of the present application to the extent that it may render a term unclear, the present description shall take precedence.

The present invention is further illustrated by the following examples. It should be understood that the following examples are for illustration purposes only, and are not used to limit the present invention thereto.

Analyses

Viscosity Number (VN) (unit: mL/g) was determined in solution in formic acid according to IS0307 standard.

Carboxylic acid End-Groups (CEG) concentration and Amine End-Groups (AEG) concentration were determined by potentiometric titration (unit: meq/kg).

Melting temperature (Tₘ) and enthalpy (AKA crystallization temperature (Tₐ) were determined by Differential Scanning calorimetry (DSC), using a Mettler DSC3 at 10° C./min.

### Example 1

Polymer (B) according to the invention was synthetized, in a stainless steel clave equipped with a mechanical stirrer, by polymerizing ε-caprolactam in the presence of bis(hexamethylene)triamine, water (30% wt) with the following molar ratio: n(bis(hexamethylene)triamine)/n(ε-caprolactam)=0.0042, R=0. The mixture was progressively heated up to 245° C., under 17.5 bar while allowing the distillation of water. The pressure was then progressively removed until atmospheric pressure. The pressure was then progressively set to 500 mbar, in 45 minutes and the temperature was kept at 245° C. Then the vacuum was broken and the polymer was extruded, cooled down in a water bath and pelletized. The removal of oligomers was done by washing several times in hot water, such that the residual content of caprolactam was below 0.3% in weight. Finally, the pellets were dried prior to analysis.

This branched polyamide had the following characteristics:

VN=108 mL/g, AEG=154 meq/kg, and CEG=38 meq/kg; and hence a AEG-CEG value of 116 meq/kg. The corresponding Mn=12700 g/mol, and the IP=1.7. The melting temperature Tm=221° C.

### Example 2

Polymer (B) according to the invention was synthetized, in a stainless steel clave equipped with a mechanical stirrer, by polymerizing ε-caprolactam in the presence of bis(hexamethylene)triamine, H3PO4 as a catalyst (370 ppm of the mixture of monomers), water (30% wt) with the following molar ratio:

n(bis(hexamethylene)triamine)/n(ε-caprolactam)=0.0042, R=0. The mixture was progressively heated up to 250° C., under 17.5 bar while allowing the distillation of water. The pressure was then progressively removed until atmospheric pressure, the temperature increased to 260° C., then kept under stirring for 1 hour. Then the polymer was extruded, cooled down in a water bath and pelletized. The removal of oligomers was done by washing several times in hot water, such that the residual content of caprolactam was below 0.3% in weight. Finally, the pellets were dried prior to analysis.

This branched polyamide had the following characteristics:

VN=117 mL/g, AEG=138 meq/kg, and CEG=20 meq/kg; and hence a AEG-CEG value of 119 meq/kg. The corresponding Mn=16500 g/mol, and the IP=1.6. The melting temperature Tm=220° C.

### Example 3

Polymer (B) according to the invention was synthetized similarly to example 2, by polymerizing ε-caprolactam in the presence of bis(hexamethylene)triamine, adipic acid, H3PO4 as a catalyst (370 ppm of the mixture of monomers), water (30% wt) with the following molar ratio: n(bis(hexamethylene)triamine)/n(ε-caprolactam)=0.008, R=n(adipic acid)/n(bis(hexamethylene)triamine)=0.5.

This branched polyamide had the following characteristics:

VN=146 mL/g, AEG=163 meq/kg, and CEG=20 meq/kg; and hence a AEG-CEG value of 144 meq/kg. The corresponding Mn=20700 g/mol, and the IP=3.0. The melting temperature Tm=216° C.

### Example 4

Polymer (B) according to the invention was synthetized similarly to example 2, by polymerizing ε-caprolactam in the presence of bis(hexamethylene)triamine, adipic acid, H3PO4 as a catalyst (370 ppm of the mixture of monomers), water (30% wt) with the following molar ratio:

n(bis(hexamethylene)triamine)/n(ε-caprolactam)=0.014, R=n(adipic acid)/n(bis(hexamethylene)triamine)=0.5.

This branched polyamide had the following characteristics:

VN=100 mL/g, AEG=273 meq/kg, and CEG=15 meq/kg; and hence a AEG-CEG value of 257 meq/kg. The corresponding Mn=13600 g/mol, and the IP=2.8. The melting temperature Tm=215° C.

### Example 5

Polymer (B) according to the invention was synthetized similarly to example 2, by polymerizing ε-caprolactam in the presence of bis(hexamethylene)triamine, adipic acid, H3PO4 as a catalyst (370 ppm of the mixture of monomers), water (30% wt) with the following molar ratio: n(bis(hexamethylene)triamine)/n(ε-caprolactam)=0.020, R=n(adipic acid)/n(bis(hexamethylene)triamine)=0.7. Here, the finishing step at atmospheric pressure, at 260° C., was kept under stirring for half an hour.

This branched polyamide had the following characteristics:

VN=105 mL/g, AEG=298 meq/kg, and CEG=18 meq/kg; and hence a AEG-CEG value of 280 meq/kg. The corresponding Mn=16500 g/mol, and the IP=4.7. The melting temperature Tm=213° C.

### Example 6

Polymer (B) according to the invention was synthetized similarly to example 2, by polymerizing ε-caprolactam in the presence of bis(hexamethylene)triamine, adipic acid, H3PO4 as a catalyst (370 ppm of the mixture of monomers), water (30% wt) with the following molar ratio: n(bis(hexamethylene)triamine)/n(ε-caprolactam)=0.020, R=n(adipic acid)/n(bis(hexamethylene)triamine)=0.7. Here, the finishing step at 260° C. was done under vacuum at 60 mbar and kept under stirring for half an hour.

This branched polyamide had the following characteristics:

VN=168 mL/g, AEG=288 meq/kg, and CEG=3 meq/kg; and hence a AEG-CEG value of 285 meq/kg. The corresponding Mn=17800 g/mol, and the IP=4.5. The melting temperature Tm=215° C.

### Comparative Example 1

This branched PA6 was synthetized similarly to example 1, by polymerizing ε-caprolactam in the presence of bis(hexamethylene)triamine, adipic acid, H3PO4 as a catalyst (370 ppm of the mixture of monomers), water (30% wt) with the following molar ratio: n(bis(hexamethylene)triamine)/n(ε-caprolactam)=0.040, R=n(adipic acid)/n(bis(hexamethylene)triamine)=0.75. Here, the finishing step was done at atmospheric pressure, at 245° C., for 1 hour.

This branched polyamide had the following characteristics:

VN=119 mL/g, AEG=491 meq/kg, and CEG=10 meq/kg; and hence a AEG-CEG value of 481 meq/kg. The corresponding Mn=11200 g/mol, and the IP=5.4. The melting temperature Tm=210° C.

Additional Raw Materials for Compounding.

The polyamide compounds were manufactured using the following ingredients:

PA6 S27, which is a linear PA6 from Solvay synthetized by polymerizing c-caprolactam in the presence of acetic acid as an end-capping agent, followed by removal of oligomers by washing in water, having VN=142 mL/g, AEG,=37 meq/kg, and CEG=54 meq/kg; and hence a AEG-CEG value of −17 meq/kg.

Acid branched PA6 SX16 from Solvay, which was a branched PA6 synthetized by polymerizing ε-caprolactam in the presence of 2,2,6,6-tetrakis(carboxyethyl)cyclohexanone as a branching agent, followed by removal of oligomers by washing in water, having VN=104 mL/g, AEG,=16 meq/kg, and CEG=180 meq/kg; and hence a AEG-CEG value of −164 meq/kg.

Glass fiber from Owens Corning of 10 μm diameter (OCV 990).

Stabilizer package containing 1.76% Cu2O, 24.56% KBr, 23.68% Carbon Black, 23.68% Nigrosin and 26,32% lubricant LT107.

General Procedure for Extrusion of Compounds.

Before compounding, pellets of polyamides were dried to decrease the water content below 1500 ppm. The compositions were obtained by melt blending of the selected ingredients in a Werner&Pleifeder ZSK 40 twin-screw extruder using the following parameters: 35 kg/hour, 230 rounds per minute, 5 heating zones: 235, 240, 245, 250, 255° C. All ingredients were fed at the beginning of the extruder. The extruder strand was cooled in a water bath, then pelletized and the obtained pellets were stored into sealed aluminium line bags to prevent moisture adsorption. Table 6 gives the composition of the compounds.

TABLE 6

| | CE2 | CE3 | CE4 | E7 |
|---|---|---|---|---|
| PA6 S27 | 69.5 | | | |
| PA6 SX16 | | 69.5 | | |
| Polyamide of | | | 69.5 | |
| Comp. Ex. 1 | | | | |
| Polyamide of Ex. 1 | | | | 69.5 |
| Stabilizer package | 0.5 | 0.5 | 0.5 | 0.5 |
| Glass fiber | 30 | 30 | 30 | 30 |

Procedure to Assess Heat-Ageing Resistance.

The compositions were injection-molded using a DEMAG H270.50 injection molding machine with a Barrel temperature around 250° C. and a mold temperatures set at 85° C., to prepare 4 mm thick ISO527 specimens. Before ageing initial mechanical properties (Tensile Modulus (E), Tensile strength at Break (TS) and elongation at break) were characterized by tensile measurements according to ISO 527/1A at 23° C. and 170° C. The average value was obtained from 5 specimens.

Then the specimens were heat-aged in a re-circulating air oven (Heraeus TK62210) set at 200° C. After 1000 and 2000h of ageing, the specimens were removed from the oven, allowed to cool to room temperature and placed into sealed aluminium lined bags until ready for testing. Mechanical properties were then measured according to ISO 527/1A, at 23° C. and 170° C. Table 7 shows that CE4 and E7 demonstrate a higher resistance to heat ageing compared to CE2 and CE3.

TABLE 7

| | | | |
|---|---|---|---|
| CE2 | CE3 | CE4 | E7 |

Initial properties

| | | | | |
|---|---|---|---|---|
| E at 23° C. | 9510 | 9700 | 9915 | 9970 |
| TS at 23° C. | 172 | 179 | 176 | 187 |
| Elong at 23° C. | 3.7 | 3 | 2.7 | 2.6 |
| E at 170° C. | 2762 | 3190 | 3080 | 3680 |
| TS at 170° C. | 45.5 | 50.2 | 37.7 | 55 |
| Elong at 170° C. | 7.8 | 6 | 3.9 | 4.7 |

Heat ageing at 200° C., 1000 h

| | | | | |
|---|---|---|---|---|
| E at 23° C. | 11150 | 10820 | 10930 | 11800 |
| TS at 23° C. | 140 | 129 | 196 | 158 |
| Elong at 23° C. | 1.5 | 1.4 | 2.8 | 1.6 |
| E at 170° C. | 5380 | 6260 | 3980 | 5760 |
| TS at 170° C. | 81.3 | 82.3 | 76.7 | 105 |
| Elong at 170° C. | 3.3 | 2.2 | 7.8 | 4.9 |

Heat ageing at 200° C., 2000 h

| | | | | |
|---|---|---|---|---|
| E at 23° C. | 10060 | 9530 | 11020 | 11700 |
| TS at 23° C. | 92 | 68 | 205.5 | 148 |
| Elong at 23° C. | 1 | 0.75 | 3 | 1.5 |
| E at 170° C. | 6110 | 6100 | 3960 | 6200 |
| TS at 170° C. | 55.9 | 39.8 | 80.4 | 93.6 |
| Elong at 170° C. | 1.5 | 0.8 | 7.3 | 2.6 |

Description of the Hot Air Pressure Pulsated Test

Box shaped parts were injection-molded using a Ferromatik K-Tec 200 injection molding machine with a Barrel temperature around 255° C. and a mold temperatures set at 85° C. Then the parts were put in an oven set at 130° C., and the interior of the box shaped parts was subjected to hot air circulation pulses, the temperature of the air being 220° C., and the pressure varying in a sinusoidal manner between 0.1 and 2.3 Bar at 1 Hz. The hot air pressure pulses were repeated until the part broke, and the number of cycles at failure was taken as an indication of material mechanical durability. 3 parts from each product were tested for repeatability.

The data in Tables 7 and 8 show that only E7 combines both heat ageing resistance and pressure pulsated test resistance.

TABLE 8

| Number of cycles for failure | CE3 | CE4 | E7 |
|---|---|---|---|
| 1st sample | 1 452 620 | 289 500 | 2 005 190 |
| 2^{nd} sample | 1 758 510 | 375 070 | 2 048 860 |
| 3^{rd} sample | 1 869 940 | 874 500 | 2 040 000 |
| Average cycles for failure | 1 693 000 | 513 000 | 2 031 000 |

1. A polyamide composition [composition (C)] comprising:
from 0 to 30% wt of at least one polyamide [polyamide (A)]; and
from above 30 to 99.99% wt of at least one branched polyamide different from polyamide (A), said branched polyamide comprising recurring units derived from polycondensation of a mixture [mixture (B)] comprising:
at least one trifunctional or tetrafunctional polyamine monomer comprising three or four amine functional groups selected from the group consisting of secondary amine group of formula —NH— and primary amine group of formula —NH₂ [monomer (FN)],
ε-caprolactam (or derivates thereof), and
at least one diacid [acid (DA)] and/or at least one diamine [amine (NN)];
wherein,
when the monomer (FN) is a trifunctional polyamine monomer, said monomer (FN) is used in an amount such that the molar ratio monomer (FN)/c-caprolactam (or derivatives thereof) is of at least 0.002 and of at most 0.030, and
when the monomer (FN) is a tetrafunctional polyamine monomer, said monomer (FN) is used in an amount such that the molar ratio monomer (FN)/c-caprolactam (or derivatives thereof) is of at least 0.001 and of at most 0.030;
said branched polyamide possessing a concentration of amine end groups (AEG) and a concentration of carboxylic end groups (CEG) such that the difference AEG-CEG is of at least 100 meq/kg and of at most 300 meq/kg [polyamide (B)]; and
from 0.01 to 3.5% wt of at least one thermal stabilizer [stabilizer (S)],
optionally, from 0 to 60% wt of at least one filler [filler(F)];
optionally, from 0 to 30% wt of at least one impact modifying rubber [rubber (I)]; and
optionally, from 0 to 30% wt of at least one impact modifying rubber [rubber (I)];
with above % wt being referred to the total weight of composition (C).

2. The composition (C) of claim 1, wherein said polyamide (A) is obtained by condensation reaction of at least one mixture selected from the group consisting of:
mixtures (M1) comprising at least a diacid [acid (DA)] (or derivative thereof) and at least a diamine [amine (NN)] (or derivative thereof);
mixtures (M2) comprising at least a lactam [lactam (L)];
mixtures (M3) comprising at least an aminocarboxylic acid [aminoacid (AN)]; and
combinations thereof.

3. The composition of claim 2, wherein said polyamide (A) is obtained by condensation reaction of at least one mixture (M1) selected from the group consisting of:
mixtures of adipic acid and 1,6-diaminohexane;
mixtures of adipic acid, terephthalic acid and 1,6-diaminohexane;
mixtures of sebacic acid and 1,6-diaminohexane,
mixtures of terephthalic acid and 1,10-diaminodecane,
mixtures of adipic acid, terephthalic acid and 1,10-diaminodecane, and
mixtures of adipic acid and 1,10-diaminodecane.

4. The composition (C) of claim 1, wherein said monomer (FN) is selected from the group consisting of tris(aminoalkyl)amines; polyoxyalkylenetriamines; polyalkylenepolyamines, which may advantageously have variable molecular weight, 1,8-diamino-4-aminomethyl-octane (TAN) and dialkylenetriamines.

5. The composition (C) according to claim 1, wherein said mixture (B) is free from any diamine [amine (NN)].

6. The composition (C) according to claim 1, wherein an acid (DA) is present in mixture (B) in an amount such that the molar ratio acid (DA)/monomer (FN) does not exceed the boundary 0.44+1/x, wherein x is the number of said amine groups in the monomer (FN).

7. The composition (C) according to claim 1, wherein said stabilizer (S) is selected from the group consisting of copper-containing stabilizers, hindered amine compounds, hindered phenol compounds, polyhydric alcohols (PHA), and phosphorous compounds.

8. The composition (C) according to claim 7, wherein said stabilizer (S) comprises at least one Copper-containing stabilizer.

9. The composition (C) of claim 8, wherein said copper-containing stabilizer comprises a copper compound [compound (Cu)] and an alkali metal halide [halide (M)] at an atomic weight ratio Cu:halide of 1:99 to 30:70.

10. A polyamide composition [composition (C)] comprising:
from 0 to 30% wt of at least one polyamide [polyamide (A)]; and
from above 30 to 99.99% wt of at least one branched polyamide different from polyamide (A), said branched polyamide comprising recurring units derived from polycondensation of a mixture [mixture (B)] comprising:
at least one trifunctional or tetrafunctional polyamine monomer comprising three or four amine functional groups selected from the group consisting of secondary amine group of formula —NH— and primary amine group of formula —NH₂ [monomer (FN)], and
ε-caprolactam (or derivates thereof);
wherein
when the monomer (FN) is a trifunctional polyamine monomer, said monomer (FN) is used in an amount such that the molar ratio monomer (FN)/ε-caprolactam (or derivatives thereof) is of at least 0.002 and of at most 0.030, and
when the monomer (FN) is a tetrafunctional polyamine monomer, said monomer (FN) is used in an amount such that the molar ratio monomer (FN)/ε-caprolactam (or derivatives thereof) is of at least 0.001 and of at most 0.030;
said branched polyamide possessing a concentration of amine end groups (AEG) and a concentration of carboxylic end groups (CEG) such that the difference AEG-CEG is of at least 100 meq/kg and of at most 300 meq/kg [polyamide (B)]; and
from 0.01 to 3.5% wt of at least one thermal stabilizer [stabilizer (S)], wherein said stabilizer (S) comprises at least one Copper-containing stabilizer;
optionally, from 0 to 60% wt of at least one filler [filler(F)];
optionally, from 0 to 30% wt of at least one impact modifying rubber [rubber (I)]; and
optionally, from 0 to 30% wt of other conventional additives, with above % wt being referred to the total weight of composition (C).

11. The composition (C) of claim 10, wherein said polyamide (A) is obtained by condensation reaction of at least one mixture selected from the group consisting of:
mixtures (M1) comprising at least a diacid [acid (DA)] (or derivative thereof) and at least a diamine [amine (NN)] (or derivative thereof);
mixtures (M2) comprising at least a lactam [lactam (L)];
mixtures (M3) comprising at least an aminocarboxylic acid [aminoacid (AN)]; and
combinations thereof.

12. The composition of claim 11, wherein said polyamide (A) is obtained by condensation reaction of at least one mixture (M1) selected from the group consisting of:
mixtures of adipic acid and 1,6-diaminohexane;
mixtures of adipic acid, terephthalic acid and 1,6-diaminohexane;
mixtures of sebacic acid and 1,6-diaminohexane,
mixtures of terephthalic acid and 1,10-diaminodecane,
mixtures of adipic acid, terephthalic acid and 1,10-diaminodecane, and
mixtures of adipic acid and 1,10-diaminodecane.

13. The composition (C) of claim 10, wherein said monomer (FN) is selected from the group consisting of tris(aminoalkyl)amines; polyoxyalkylenetriamines; polyalkylenepolyamines, which may advantageously have variable molecular weight, 1,8-diamino-4-aminomethyl-octane (TAN) and dialkylenetriamines.

14. The composition (C) according to claim 10, wherein said mixture (B) additionally comprises at least one diacid [acid (DA)] and/or at least one diamine [amine (NN)].

15. The composition (C) according to claim 10, wherein said mixture (B) is free from any diamine [amine (NN)].

16. The composition (C) according to claim 14, wherein an acid (DA) is present in mixture (B) in an amount such that the molar ratio acid (DA)/monomer (FN) does not exceed the boundary 0.44+1/x, wherein x is the number of said amine groups in the monomer (FN).

17. The composition (C) of claim 10, wherein said copper-containing stabilizer comprises a copper compound [compound (Cu)] and an alkali metal halide [halide (M)] at an atomic weight ratio Cu:halide of 1:99 to 30:70.

18. A method for manufacturing an article by shaping the composition (C) according to claim 1, by any shaping technique.

19. The method according to claim 18, wherein the article is selected from the group consisting of films, yarns, fibers, laminates, automotive parts, engine parts and electrical/electronics parts.

20. A method of making a polyamide composition [composition (C)] comprising:
from 0 to 30% wt of at least one polyamide [polyamide (A)]; and
from above 30 to 99.99% wt of at least one branched polyamide different from polyamide (A), said branched polyamide comprising recurring units derived from polycondensation of a mixture [mixture (B)] comprising:
at least one trifunctional or tetrafunctional polyamine monomer comprising three or four amine functional groups selected from the group consisting of secondary amine group of formula —NH— and primary amine group of formula —NH₂ [monomer (FN)], and
ε-caprolactam (or derivates thereof);
wherein
when the monomer (FN) is a trifunctional polyamine monomer, said monomer (FN) is used in an amount such that the molar ratio monomer (FN)/ε-caprolactam (or derivatives thereof) is of at least 0.002 and of at most 0.030, and
when the monomer (FN) is a tetrafunctional polyamine monomer, said monomer (FN) is used in an amount such that the molar ratio monomer (FN)/ε-caprolactam (or derivatives thereof) is of at least 0.001 and of at most 0.030;
said branched polyamide possessing a concentration of amine end groups (AEG) and a concentration of carboxylic end groups (CEG) such that the difference AEG-CEG is of at least 100 meq/kg and of at most 300 meq/kg [polyamide (B)]; and
from 0.01 to 3.5% wt of at least one thermal stabilizer [stabilizer (S)],
optionally, from 0 to 60% wt of at least one filler [filler(F)];
optionally, from 0 to 30% wt of at least one impact modifying rubber [rubber (I)]; and
optionally, from 0 to 30% wt of other conventional additives,
with above % wt being referred to the total weight of composition (C),
said method comprising melt-blending the polyamide (A), the polyamide (B), the thermal stabilizer, and of any other optional ingredient.

21. The method (C) of claim 20, wherein said polyamide (A) is obtained by condensation reaction of at least one mixture selected from the group consisting of:
mixtures (M1) comprising at least a diacid [acid (DA)] (or derivative thereof) and at least a diamine [amine (NN)] (or derivative thereof);
mixtures (M2) comprising at least a lactam [lactam (L)];
mixtures (M3) comprising at least an aminocarboxylic acid [aminoacid (AN)]; and
combinations thereof.

22. The method of claim 21, wherein said polyamide (A) is obtained by condensation reaction of at least one mixture (M1) selected from the group consisting of:
mixtures of adipic acid and 1,6-diaminohexane;
mixtures of adipic acid, terephthalic acid and 1,6-diaminohexane;
mixtures of sebacic acid and 1,6-diaminohexane,
mixtures of terephthalic acid and 1,10-diaminodecane,
mixtures of adipic acid, terephthalic acid and 1,10-diaminodecane, and
mixtures of adipic acid and 1,10-diaminodecane.

23. The method (C) of claim 20, wherein said monomer (FN) is selected from the group consisting of tris(aminoalkyl)amines; polyoxyalkylenetriamines; polyalkylenepolyamines, which may advantageously have variable molecular weight, 1,8-diamino-4-aminomethyl-octane (TAN) and dialkylenetriamines.

24. The method (C) according to claim 20, wherein said mixture (B) additionally comprises at least one diacid [acid (DA)] and/or at least one diamine [amine (NN)].

25. The method (C) according to claim 20, wherein said mixture (B) is free from any diamine [amine (NN)].

26. The method (C) according to claim 24, wherein an acid (DA) is present in mixture (B) in an amount such that the molar ratio acid (DA)/monomer (FN) does not exceed the boundary 0.44+1/x, wherein x is the number of said amine groups in the monomer (FN).

27. The method (C) according to claim 20, wherein said stabilizer (S) is selected from the group consisting of copper-containing stabilizers, hindered amine compounds, hindered phenol compounds, polyhydric alcohols (PHA), and phosphorous compounds.

28. The method (C) according to claim 27, wherein said stabilizer (S) comprises at least one Copper-containing stabilizer.

29. The method (C) of claim 28, wherein said copper-containing stabilizer comprises a copper compound [compound (Cu)] and an alkali metal halide [halide (M)] at an atomic weight ratio Cu:halide of 1:99 to 30:70.

30-33. (canceled)
